(19) United States
(12) Patent Application Publication
(10) Pub. No.: US 2025/0213407 A1
(43) Pub. Date: Jul. 3, 2025

(54) RISING SEAT FOR A WHEELCHAIR

(71) Applicant: LIFE ASSITANT LTD, Afula (IL)

(72) Inventors: Iftah GEVA, Kibbutz Reshafim (IL); Gal GOLDNER, Kibbutz Ginegar (IL)

(21) Appl. No.: 18/853,447

(22) PCT Filed: Apr. 3, 2023
(86) PCT No.: PCT/IL2023/050354

§ 371 Date: Oct. 2, 2024

Related U.S. Application Data
(60) Provisional application No. 63/326,866, filed on Apr. 3, 2022.

(51) Int. Cl. A61G 5/10; A61G 5/14

(52) U.S. Cl. CPC A61G 5/1045; A61G 5/14; A61G 2203/10; A61G 2203/34

(57) ABSTRACT

A rising seat system and method are provided for wheelchairs. The rising seat system comprises a seat outer portion wrapping an inflatable interior cushion wherein the outer seat portion is deployed, extended, or stretched when the inflatable interior cushion is being inflated and withdrawn to its original size when the inflatable interior cushion is deflated, and an adjunct outer packaging portion connected to the seat outer portion, wherein the outer packaging portion is configured to maintain at least a battery and a pump for inflating and deflating the inflatable interior cushion. According to the method the seat outer portion is placed on the seat of the wheelchair and the adjunct outer packaging portion is passed through the slot between the seat of the wheelchair and the backrest of the wheelchair so that the connection zone is placed substantially within the slot. The adjunct outer packaging portion is hanged on the handles of the wheelchair.

### CROSS-REFERENCE TO RELATED APPLICATION

This application claims priority to U.S. Provisional Patent Application No. 63/326,866, filed Apr. 3, 2022, the entire contents of which is incorporated herein by reference in its entirety.

### TECHNICAL FIELD

The present disclosed subject matter relates to rising seats. More particularly, the present disclosed subject matter relates to rising seats that are compatible with wheelchairs.

### BACKGROUND

People that are disabled, sick, or merely elderly people may need assistance in getting up from a sitting position to a standing position. Rising seats that are adjunct to a chair or a sofa and rising seats that are portable and can be placed on a random seat are known in the art. People using wheelchairs are prone to have difficulties in getting up from a sitting position; however, although some of the rising seats of the art are portable, they are not compatible with wheelchairs.

There is a need to provide a rising seat that is compatible to be installed on a wheelchair while it is stably mounted on the wheelchair's seat and doesn't interrupt the caretaker of the disabled person.

### SUMMARY

According to an embodiment of the present subject matter, a rising seat system for wheelchairs is provided that comprises:
a seat outer portion wrapping an inflatable interior cushion wherein the outer seat portion is deployed, extended, or stretched when the inflatable interior cushion is being inflated and withdrawn to its original size when the inflatable interior cushion is deflated, and
an adjunct outer packaging portion connected to the seat outer portion, wherein the outer packaging portion is configured to maintain at least a battery and a pump for inflating and deflating the inflatable interior cushion.

According to another embodiment, the system further comprises a connection zone connecting the seat outer portion and the adjunct outer packaging portion.

According to another embodiment, the seat outer portion is made of a material selected from a group of materials that are flexible, extendable, stretchable, a combination thereof or the like.

According to another embodiment, a controller is provided within the adjunct outer packaging portion, wherein the controller is configured to control the operation and coordination of and between the pump and the battery.

According to another embodiment, the rising seat is provided with at least one sensor configured to sense air pressure within the inflatable interior cushion and provide an alert to the controller to stop or start the operation of the pump.

According to another embodiment, the inflatable interior cushion is made of a fluid-proof material.

According to another embodiment, the fluid-proof material is nylon fabric covered with polyurethane.

According to another embodiment, the inflatable interior cushion comprises at least one compartment.

According to another embodiment, the at least one compartment is at least two compartments and wherein upon inflating the inflatable interior cushion, some of the compartments are configured to be inflated and other compartments stay in an uninflated state.

According to another embodiment, the seat outer portion is made of fabric.

According to another embodiment, an upper side of the seat outer portion has a pattern that is selected from a pattern such as coarse, rough, jagged, a combination thereof or the like.

According to another embodiment, the inflatable cushion can be integrated with the outer portion so that a single layer is provided.

According to another embodiment, the connection zone is flexible and bendable.

According to another embodiment, at least the battery and the pump are electrically connected.

According to another embodiment, at least one tube that is fluidically connected is connecting the pump and the inflatable interior cushion.

According to another embodiment, a tube that is fluidically connected is connecting the pump and the inflatable interior cushion and pass through the connecting zone.

According to another embodiment, the packaging portion is provided with two bands positioned on both sides of the packaging portion, wherein each band is configured to hang on handles of the wheelchair.

According to another embodiment, the rising seat system further provided with an interface through which a user can interact with the controller.

According to yet another embodiment, a method is provided for installing a rising seat system on a wheelchair having a slot between a seat and a backrest of the wheelchair and handles by which a caregiver of a user can move the wheelchair, the method comprising:
placing the seat outer portion on the seat of the wheelchair;
passing the adjunct outer packaging portion through the slot between the seat of the wheelchair and the backrest of the wheelchair so that the connection zone is placed substantially within the slot; and
hanging the adjunct outer packaging portion on the handles of the wheelchair, wherein when the user needs to get seated on or get up from the wheelchair, the seat outer portion is being inflated and when the user is seating on the seat of the wheelchair, the seat outer portion is being deflated.

According to another embodiment, the user or the caregiver can interact with the rising seat system through the interface so as to inflate or deflate the seat outer portion.

### BRIEF DESCRIPTION OF THE DRAWINGS

Some embodiments of the disclosed subject matter described, by way of example only, with reference to the accompanying drawings. With specific reference now to the drawings in detail, it is stressed that the particulars shown are by way of example and for purposes of illustrative discussion of the preferred embodiments of the present disclosed subject matter only, and are presented in the cause of providing what is believed to be the most useful and readily understood description of the principles and conceptual aspects of the disclosed subject matter. In this regard, no attempt is made to show structural details of the disclosed subject matter in more detail than is necessary for a fundamental understanding of the disclosed subject matter, the description taken with the drawings making apparent to those skilled in the art how the several forms of the disclosed subject matter may be embodied in practice.

In the drawings:

FIG. 1A schematically illustrates a rising seat for disabled people that can be safely incorporated within a wheelchair, in accordance with some exemplary embodiments of the disclosed subject matter;

FIG. 1B schematically illustrates a rising seat system of FIG. 1A, in accordance with some exemplary embodiments of the disclosed subject matter;

FIG. 1C schematically illustrates a rising seat system of FIG. 1A, in accordance with some other exemplary embodiments of the disclosed subject matter;

FIG. 2A illustrates a first stage of mounting the rising seat shown in FIGS. 1A and 1B onto a wheelchair-frontal view, in accordance with some exemplary embodiments of the disclosed subject matter;

FIG. 2B illustrates a first stage of mounting the rising seat shown in FIGS. 1A and 1B onto a wheelchair-back view, in accordance with some exemplary embodiments of the disclosed subject matter;

FIG. 3A illustrates the wheelchair with the rising seat system in a stage ready to be sited on and the wheelchair with the rising seat in an inflatable state, respectively, in accordance with some exemplary embodiments of the disclosed subject matter; and

FIG. 3B illustrates the wheelchair with the rising seat in an inflatable state, in accordance with some exemplary embodiments of the disclosed subject matter.

### DETAILED DESCRIPTION

Before explaining at least one embodiment of the disclosed subject matter in detail, it is to be understood that the disclosed subject matter is not limited in its application to the details of construction and the arrangement of the components set forth in the following description or illustrated in the drawings. The disclosed subject matter is capable of other embodiments or of being practiced or carried out in various ways. Also, it is to be understood that the phraseology and terminology employed herein is for the purpose of description and should not be regarded as limiting. The drawings are generally not to scale. For clarity, non-essential elements were omitted from some of the drawings.

It is an object of the present subject matter to provide a portable rising seat that is compatible to be installed on a wheelchair while it is stably mounted on the wheelchair's seat and doesn't interrupt the caretaker of the disabled person.

The rising seat for wheelchairs according to the present subject matter comprises an inflatable interior cushion provided within a seat outer portion of the wheelchair's rising seat. The seat outer portion is made of a material that is flexible, extendable, stretchable, a combination thereof or the like. The outer seat portion can be deployed, extended, or stretched when the inflatable interior cushion is being inflated with air and withdrawn to its original size when air is deflated from the interior cushion.

The rising seat according to the present subject matter further comprises an adjunct outer packaging portion that is configured to maintain at least a battery and a pump for inflating and deflating the inflatable interior cushion.

Optionally or additionally, a connecting zone is connecting the outer seat portion and the adjunct outer packaging portion.

Optionally or additionally, a controller is provided in the outer packaging portion. The controller is configured to control the operation and coordination of and between the pump and the battery.

Optionally or additionally, the rising seat is provided with at least one sensor configured to sense the pressure of air within the inflatable interior cushion and provide an alert to the controller to stop or start the operation of the pump. Additional sensors can be provided so as to ensure the safe operation of the rising seat for wheelchairs.

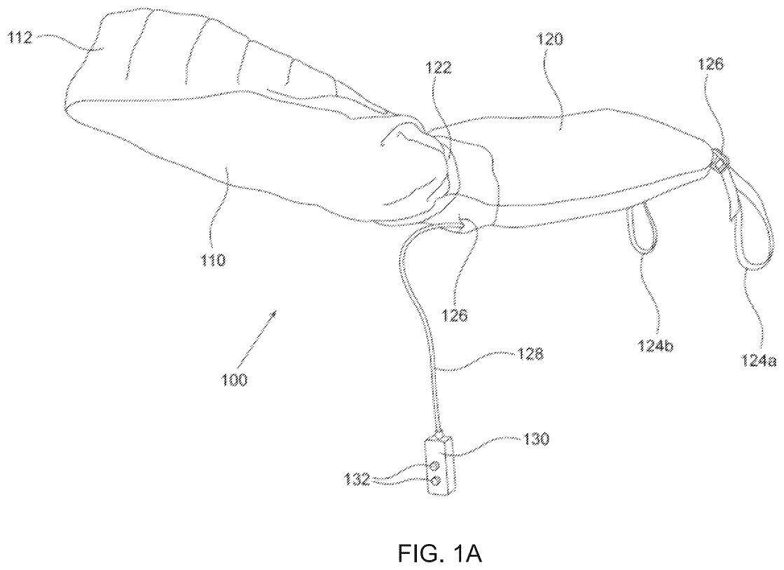

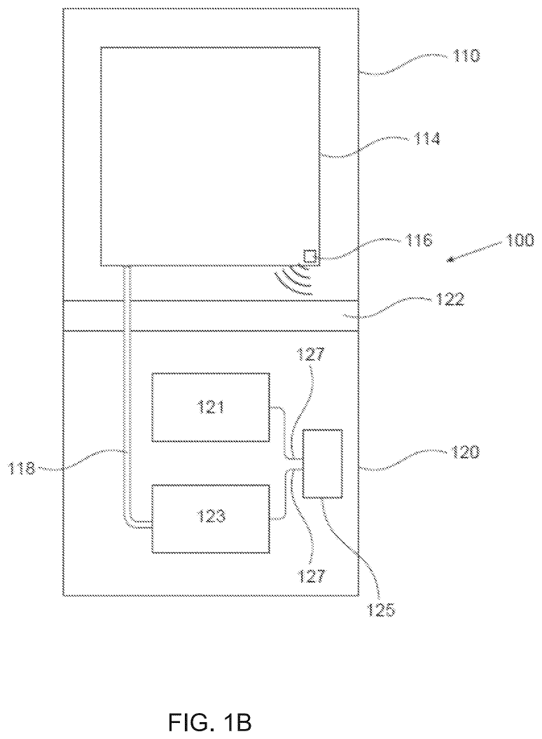

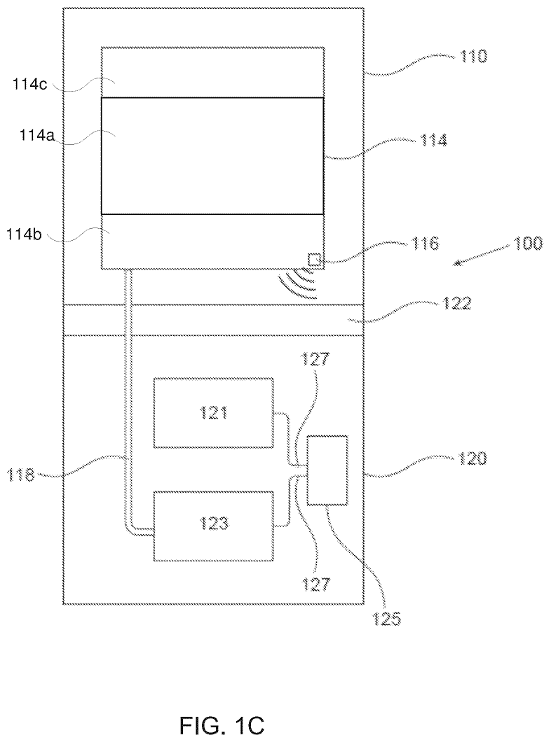

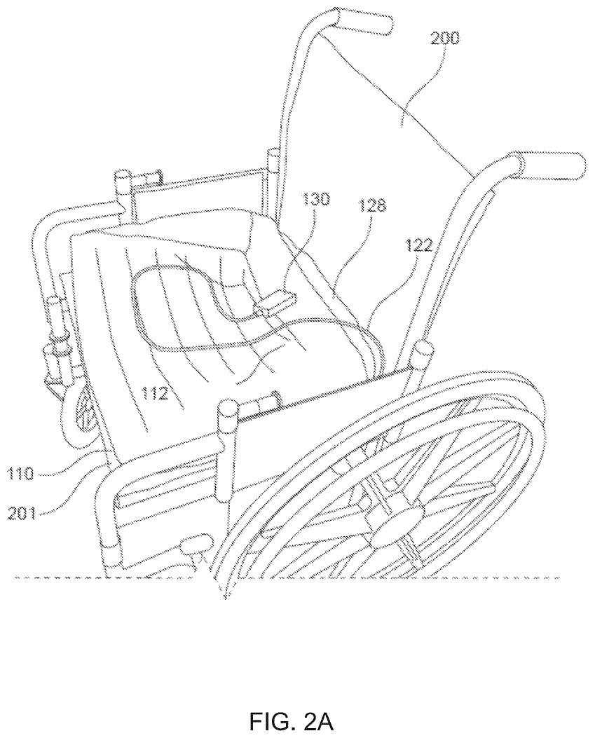

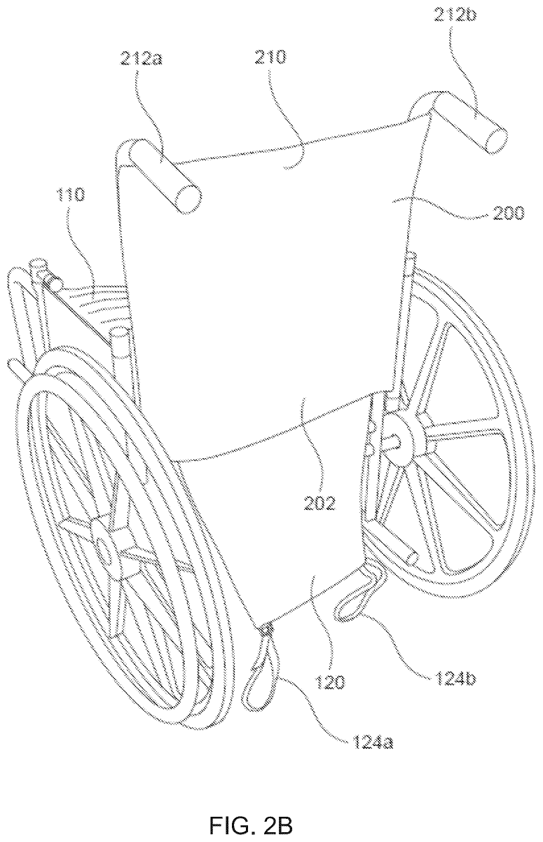

Reference is now made to FIG. 1A and 1B schematically illustrating a rising seat for disabled people that can be safely incorporated within a wheelchair and a rising seat system, respectively, in accordance with some exemplary embodiments of the disclosed subject matter. A rising seat 100 is shown to have two portions-a seat portion 110 and an adjunct packaging portion 120. The seat portion 110 is sized to be mounted on a standard wheelchair's seat (shown at least in FIGS. 2A and 2B). The seat portion is made of two parts, an interior portion that is inflatable and a seat outer portion that is flexible, extendable, stretchable, a combination thereof or the like that wraps the inflatable interior cushion 114. The inflatable cushion is preferably made of a material that is fluid proof such as nylon fabric covered with polyurethane, any other combination or the like.

Optionally or additionally, the cushion can be provided with more than a single compartment so that not all compartments are inflated and the others are inflated according to the specific need and according to the weight that the cushion has to endure. In case there are at least two compartments; upon inflating the inflatable interior cushion, some of the compartments are configured to be inflated and other compartments stay in an uninflated state.

Reference is now made to 1C schematically illustrating a rising seat system of FIG. 1A, in accordance with some other exemplary embodiments of the disclosed subject matter.

The inflatable interior cushion 114 is divided into more than a single compartment-in this case, three compartments 114a, 114b, and 114c. Any number of compartments can be provided.

Optionally or additionally, the compartments are arranged in levels so that the height to which the cushion is inflated can be determined according to the number of levels that are inflated.

The seat outer portion is preferably made of a fabric that is comfortable to seat on. The upper side 112 of the seat outer portion 110 preferably have a pattern that is coarse, rough, jagged, a combination thereof or the like so that the person seating on the seat is not slipping from it and can securely and safely seat on the seat portion 110.

Optionally and additionally, the inflatable cushion can be integrated with the outer portion so that a single layer is provided.

Optionally or additionally, the packaging portion 120 is an adjunct portion to the seat portion 110 and is connected to it along the width of the seat portion in a connection zone 122 that is adapted to connect the packaging portion to the seat portion. The connection zone 122 is flexible and bendable, however, it is not inflatable or extendable.

Optionally and additionally, electrical wiring 127 is provided between the units in the outer packaging portion 120 while at least one tube 118 that is fluidically connected between the interior cushion 114 in the seat portion 110 and the pump 123 in the outer packaging portion 120. The tube 118 passes from one portion to the other through the connection zone 122.

Opposite to the connection zone 122, the packaging portion 120 is provided with two bands 124a and 124b that are positioned on both sides of the packaging portion 120. The bands 124a and 124b are provided with a buckle 126 so as to adjust the length of the bands.

The packaging portion 120 is further provided with a slot 126 configured to allow wiring 128 to pass within while maintaining an electrical connection between the pump that is in the outer packaging portion and an operating interface 130 through which the person in need or his/her caregiver can operate the pump to start or stop inflating the cushion.

The interface 130 is provided with buttons 132 onto which the person in need or his/her caregiver can provide instructions to the system.

The outer packaging portion 120 is configures to maintain at least a battery 121 and a pump 123 for inflating and deflating the inflatable interior cushion 114.

Optionally or additionally, a controller 125 is provided in the outer packaging portion 120 wherein the controller is configured to control the operation and coordination of and between the pump 123 and the battery 121. Other portions of the rising seat system 100 can be controlled using the same controller 125 or another controller.

Optionally or additionally, valves are provided in order to control the flow or air from the pump to the cushion and vice versa.

Optionally or additionally, the rising seat is provided with at least one sensor 116 configured to sense the pressure of air within the inflatable interior cushion 114 and provide an alert to the controller 125 to stop or start the operation of the pump. The sensor can be wired to the controller or to other parts of the system or can transfer parameters using a wireless means such as, but not limited to, WiFi or Bluetooth. Additional sensors can be provided so as to ensure the safe operation of the rising seat for wheelchairs.

Reference is now made to FIGS. 2A and 2B illustrating a first stage of mounting the rising seat shown in FIGS. 1A and 1B onto a wheelchair-frontal and back views, respectively, in accordance with some exemplary embodiments of the disclosed subject matter. As shown in FIG. 2A, the seat portion 110 is mounted on a wheelchair 200 on its seat 201. The upper side 112 of the seat outer portion 110 is configured to be beneath the person that needs to seat on the wheelchair 200, wherein the seat portion is between the seta of the wheelchair 201 and the sitting person.

As shown in FIG. 2B, the outer packaging portion 120 is suspended in the back side of the wheelchair while the connecting portion 122 is in between the packaging portion is transferred from the frontal side of the wheelchair, after the seat portion is placed on the seat of the wheelchair, to the back side of the wheelchair through a slot 202 between the seat of the wheelchair 201 and the backrest of the wheelchair 210.

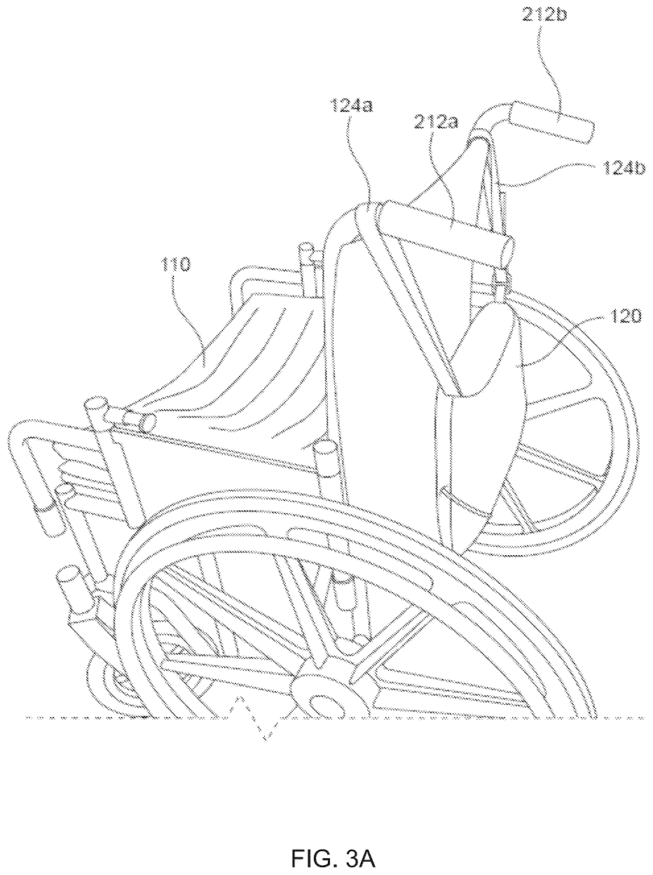

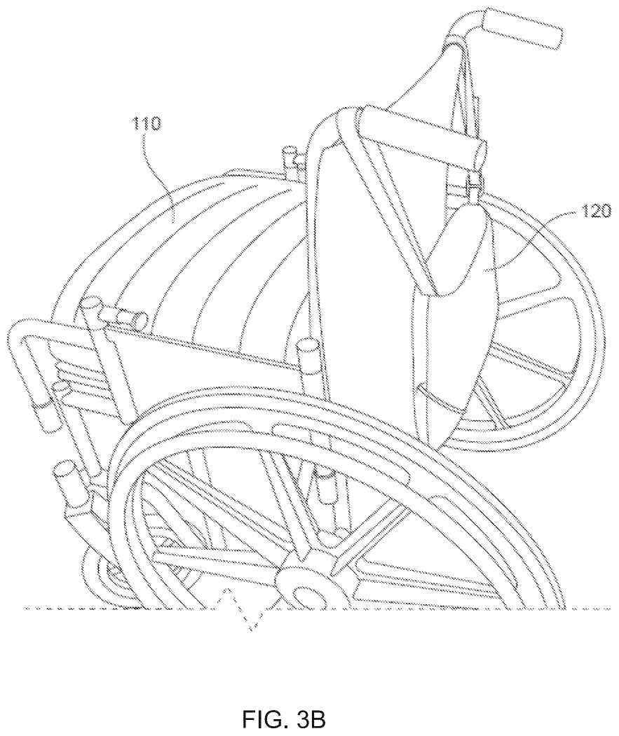

Reference is now made to FIG. 3A and 3B illustrating the wheelchair with the rising seat system in a stage ready to be sited on and the wheelchair with the rising seat in an inflatable state, respectively, in accordance with some exemplary embodiments of the disclosed subject matter.

The next stage after the stage shown in FIG. 2B in which the packaging portion is suspended below the seat of the wheelchair is that this portion is being pulled over and suspended using the bands 124a and 124b that are hung on the handles 212a and 212b of the wheelchair 200. In this way, the pump and battery is not disturbing the caretaker of the person that uses the wheelchair and is integrated in the wheelchair so that the seat cannot fall or be unstable on the seat of the wheelchair.

It is another object of the present subject matter to provide a method for installing the rising seat system as described herein on a wheelchair having a slot between a seat and a backrest of the wheelchair and handles by which a caregiver of a user can move the wheelchair. According to the method, the seat outer portion is placed on the seat of the wheelchair, and the adjunct outer packaging portion is passed through the slot between the seat of the wheelchair and the backrest of the wheelchair so that the connection zone is placed substantially within the slot area. Then the adjunct outer packaging portion is hanged on the handles of the wheelchair. When the user needs to get seated on or get up from the wheelchair, the seat outer portion is being inflated and when the user is seating on the seat of the wheelchair, the seat outer portion is being deflated.

FIG. 3B shows the wheelchair with the rising seat system 100 in which the seat portion 110 is shown to be inflated allowing the using person to rise from the chair or the seat on it safely.

According to the method of the present subject matter, the disabled person or his/her caretaker is inflating or deflating the inflatable cushion using the interface 130. As mentioned herein before, the interface is being wirily connected to the pump by the tube 128 so that the interface can be situated in a close proximity to the person or the caretaker. The rising seat system is used to lift or lower the person, assisting him/her to rise from the seat or sit on it.

It should be noted that the packaging portion can be opened in order to remove the pump or charge the battery, change those elements for maintenance, a combination thereof or the like.

Although the subject matter has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present subject matter.

1. A rising seat system for wheelchairs comprising:
a seat outer portion wrapping an inflatable interior cushion wherein the outer seat portion is deployed, extended, or stretched when the inflatable interior cushion is being inflated and withdrawn to its original size when the inflatable interior cushion is deflated, and
an adjunct outer packaging portion connected to the seat outer portion, wherein the outer packaging portion is configured to maintain at least a battery and a pump for inflating and deflating the inflatable interior cushion.

2. The rising seat system for wheelchairs as claimed in claim 1, which further comprises a connection zone connecting the seat outer portion and the adjunct outer packaging portion.

3. The rising seat system for wheelchairs as claimed in claim 1, wherein the seat outer portion is made of a material selected from a group of materials that are flexible, extendable, stretchable, or a combination thereof.

4. The rising seat system for wheelchairs as claimed in claim 1, wherein a controller is provided within the adjunct outer packaging portion, wherein the controller is configured to control the operation and coordination of and between the pump and the battery.

5. The rising seat system for wheelchairs as claimed in claim 1, wherein the rising seat is provided with at least one sensor configured to sense air pressure within the inflatable interior cushion and provide an alert to the controller to stop or start the operation of the pump.

6. The rising seat system for wheelchairs as claimed in claim 1, wherein the inflatable interior cushion is made of a fluid-proof material.

7. The rising seat system for wheelchairs as claimed in claim 6, wherein the fluid-proof material is nylon fabric covered with polyurethane.

8. The rising seat system for wheelchairs as claimed in claim 1, wherein the inflatable interior cushion comprises at least one compartment.

9. The rising seat system for wheelchairs as claimed in claim 8, wherein the inflatable interior cushion comprises at least two compartments and wherein upon inflating the inflatable interior cushion, some of the compartments are configured to be inflated and other compartments stay in an uninflated state.

10. The rising seat system for wheelchairs as claimed in claim 1, wherein the seat outer portion is made of fabric.

11. The rising seat system for wheelchairs as claimed in claim 10, wherein an upper side of the seat outer portion has a pattern that is selected from a pattern such as coarse, rough, jagged, or a combination thereof.

12. The rising seat system for wheelchairs as claimed in claim 1, wherein the inflatable cushion can be integrated with the outer portion so that a single layer is provided.

13. The rising seat system for wheelchairs as claimed in claim 2, wherein the connection zone is flexible and bendable.

14. The rising seat system for wheelchairs as claimed in claim 1, wherein at least the battery and the pump are electrically connected.

15. The rising seat system for wheelchairs as claimed in claim 1, wherein a tube that is fluidically connected is connecting the pump and the inflatable interior cushion.

16. The rising seat system for wheelchairs as claimed in claim 1, wherein at least one tube that is fluidically connected is connecting the pump and the inflatable interior cushion and pass through the connecting zone.

17. The rising seat system for wheelchairs as claimed in claim 1, wherein the packaging portion is provided with two bands positioned on both sides of the packaging portion, wherein each band is configured to hang on handles of the wheelchair.

18. The rising seat system for wheelchairs as claimed in claim 4, wherein the rising seat system is further provided with an interface through which a user can interact with the controller.

19. A method for installing the rising seat system of claim 1 on a wheelchair having a slot between a seat and a backrest of the wheelchair and handles by which a caregiver of a user can move the wheelchair, the method comprising:
placing the seat outer portion on the seat of the wheelchair;
passing the adjunct outer packaging portion through the slot between the seat of the wheelchair and the backrest of the wheelchair so that the connection zone is placed substantially within the slot; and
hanging the adjunct outer packaging portion on the handles of the wheelchair,
wherein when the user needs to get seated on or get up from the wheelchair, the seat outer portion is being inflated and when the user is seating on the seat of the wheelchair, the seat outer portion is being deflated.

20. The method as claimed in claim 19, wherein the user or the caregiver can interact with the rising seat system through the interface so as to inflate or deflate the seat outer portion.
